(19) United States
(12) Patent Application Publication
(10) Pub. No.: US 2025/0270370 A1
(43) Pub. Date: Aug. 28, 2025

(54) Polymers with thioamide repeating units

(71) Applicant: Helsingin Yliopisto, Helsingin yliopisto (FI)

(72) Inventors: Askican Hacioglu, Helsingin yliopisto (FI); Andrew Kerr, Helsingin yliopisto (FI); Robert Luxenhofer, Würzburg (DE)

(21) Appl. No.: 18/588,416

(22) Filed: Feb. 27, 2024

(51) Int. Cl. C08G 69/48

(52) U.S. Cl. CPC C08G 69/48

(57) ABSTRACT

The present invention relates to polythioamides having their thioamide repeating units at least partly positioned in sidechains of the polymer, to a method for preparing such polymers, as well as to suitable applications of such polymers.

### FIELD

The present invention relates to polythioamides having their thioamide repeating units at least partly positioned in side chains of the polymer. The invention also relates to a method for preparing such polymers, as well as to suitable applications of such polymers.

### BACKGROUND

Thioamides are single atom substitutes of amides wherein the carbonyl oxygen atom is replaced with sulfur. The general Formula of a thioamide is shown below:

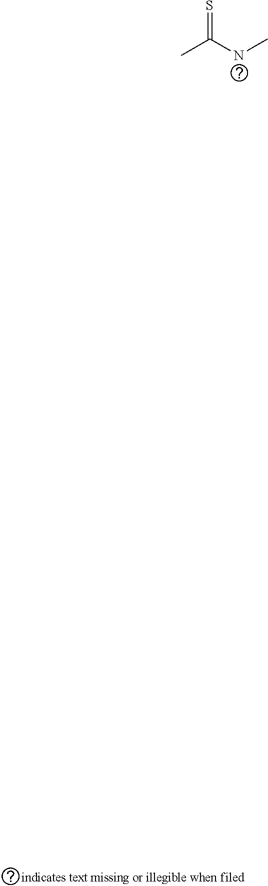

Benefits of thioamide incorporation into peptides, proteins, and other amide compounds can be dramatic due to their physicochemical properties. Thioamides are more reactive than amides, and therefore have been used as chemical synthesis intermediates. Although they offer several benefits in biomedical usage, thioamides are exceptionally rare in nature. Most reported natural thioamides are of bacterial origin, except for some plant derived alternatives. Therefore, to obtain a larger variation of thioamide products, they are typically synthetically prepared (see e.g. EP2484655A1).

Thioamides and thiocarbonyls can be obtained via phosphorus pentasulfide (P₄S₁₀) and different thionation agents such as O,O-diethyldithiophosphonic acid, boron sulfide, silicon disulfide, and elemental sulfur in hexamethylphosphoramide. However, from the 20^{th} century, the Lawesson's reagent (LR) has become the gold standard for obtaining thio-analogs of carbonyls, amides, hydroxyls and esters.

Thioamide polymers have also been described and synthetically prepared in the past (see e.g. M. Delêtre and G. Levesque, 1990), and used e.g. as chemical reagents, or free-radical generators. These polymers are also interesting candidates in drug delivery systems. Further, there are commercially available pharmaceutical compounds containing thiocarbonyl or thioamide groups.

Most thioamides described in the past are, however, monomers, and even the polythioamides that have been investigated have been polymers with the thioamide group in their polymer backbone, thus resulting in a limited variation in the reactivity and applicability of these polymers. Therefore, there is still a need for further investigation into the types of polythioamides that can be prepared, and the properties of these.

### SUMMARY OF THE INVENTION

The invention is defined by the features of the independent claims. Some specific embodiments are defined in the dependent claims.

According to a first aspect of the present invention, there is provided a novel group of thioamide polymers having their thioamide repeating groups at least partly in their side chains.

In particular embodiments, the polythioamides of the invention are the thionated products of poly(2-oxazolines), poly(2-oxazines), polyacrylamides, polymethacrylamides, poly(n-acryloyl glycinamide), and polyvinylcaprolactam, but shall not be limited to these.

According to a second aspect of the present invention, there is provided a method for preparing polythioamides from the corresponding amides with a high variety of possible products.

According to a further aspect of the invention, there is provided the use of said polythioamides in biocidal, pharmaceutical, agrochemical, diagnostic, or adhesive formulations.

The present invention thus relates to polythioamides having their thioamide repeating units at least partly positioned in sidechains of the polymer. Typically, these polythioamides have a degree of substitution (DS) value of 1%, while it is preferred to have at least 5% of the amide repeating units thionated, more preferably at least 10%, and most suitably at least 20%.

Further, the invention relates to a method for preparing such polymers by reacting a polyamide having its amide repeating units at least partly in a side chain of the polymer with a suitable thionation reagent.

In an exemplary method, utilizing the Lawesson's reagent for the thionations, the thionation can proceed according to the following reaction scheme (I), showing a typical thionation mechanism for the LR reagent, proceeding via a cycloconversion step:

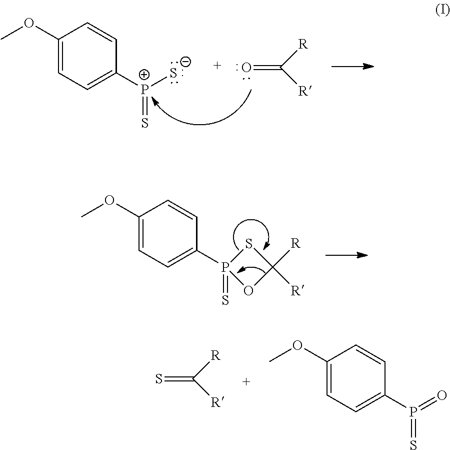

The same reaction, shown in Scheme (I), for a carbonyl group in general, can be utilized for the thionation of amides. Using the present invention, and a reaction involving the use of one of the herein mentioned thionation reagents, a group of polyamides can be obtained that are highly suitable for use in biocidal, pharmaceutical, agrochemical, diagnostic, or adhesive formulations.

Several advantages are achieved with the present polythioamides and their preparation methods. Among others, polythioamides can be obtained that are more reactive than polyamides. The polythioamides of the invention, having their polyamide groups at least partly in their side groups, also have a lower oxidation potential, as well as a particularly high affinity for metals, such as copper. The thioamide group offers a significant change in the physicochemical properties of peptides, proteins or other polymers, into which they are incorporated, as compared to the properties of the corresponding polyamides, and are highly useful as intermediates in chemical syntheses. Further, they offer a prolonged circulation time in drug delivery systems.

### BRIEF DESCRIPTION OF THE DRAWINGS

FIG. 1 shows stacked ¹H NMR spectra of S0, S3, S12, S16, S20 and S42 in CD₃CN.

FIG. 2 shows IR spectra of S0, S3, S12, S16, S20 and S42. Carbonyl stretches shifts through 1635 cm-1 from 1624 cm-1 with increasing thionation. New bands form at 1033 cm-1, while the absorbance decreases at 1060 cm-1.

FIG. 3 shows transmittance measurements of S0, S3, S12, S16 and S20 in a range of temperature and concentration.

### EMBODIMENTS

### Definitions

In the present context, “Lawesson's reagent” (or LR) refers to 2,4-bis(4-methoxyphenyl)-2,4-dithioxo-1,3,2,4-dithiadiphosphetane (C₁₄H₁₄O₂P₂S₄), herein used as a thionation reagent.

Likewise, the term “Berzelius reagent” refers to 1,3,5,7-tetrakis(sulfanylidene)-2,4,6,8,9,10-hexathia-1λ⁵,3λ⁵,5λ⁵,7λ⁵-tetraphosphatricyclo-[3.3.1.1^{3,7}]decane (also called phosphorus pentasulphide, P₄S₁₀), and the term “Davy's reagent” refers to 2,4-Bis(p-tolylthio)-1,3,2,4-dithiadiphosphetane 2,4-disulfide (C₁₄H₁₄P₂S₆), both used for thionation reactions. A further useful thionation reagent is pentathiodiphosphorus(V) acid-P,P′-bis(pyridinium betaine) (C₁₀H₁₀N₂P₂S₅).

The polyamides used herein refer to polymers having a monomeric repeating structure, wherein the backbone and/or the side chain of the polymer comprises one or more amide groups. Typically, each monomeric unit comprises at least one amide group.

The present invention also relates to polythioamides formed of monomeric structures containing thioamide repeating units at least partly positioned in their side chains. This polythioamide has a degree of substitution of at least 1%, preferably at least 5%, most suitably at least 20%.

In an embodiment, the polythioamide is selected from the thionated product of a poly(2-oxazoline), poly(2-oxazine), polyacrylamides, polymethacrylamides, polyvinylpyrrolidone or poly(n-acryloyl glycinamide).

The structure of said polythioamide preferably contains thioamide repeating units positioned entirely in the polymer side chains. This option increases the reactivity of the structures, e.g. in click reactions. For example, these polythioamides can take part in reactions with sulfonyl azides resulting amidine moieties. Thus, the polythioamide may be selected, for example, from the thionated product of a polyacrylamides, polymethacrylamides, polyvinylpyrrolidone or poly(n-acryloyl glycinamide).

In certain embodiments, said polythioamide consists fully of thioamide repeating units, i.e. represents a homopolymer. Alternatively, the thioamide repeating units are part of a copolymer, either in a random, gradient, graft or block copolymer fashion.

In an embodiment, the polythioamide polymer comprises at least 7 repeating units of a monomer including the thioamide group, preferably at least 10 repeating units of, for example, 10 to 10,000 repeating units of said monomer, more preferably 20 to 5000 repeating units, and most suitably 40 to 1000.

In a further embodiment, at least 1% of said repeat units comprise a thioamide group, and the resulting polymer is a random, gradient, graft or block copolymer. If 100% of repeating units comprise the thioamide, the resulting polymer is a homopolymer.

Moreover, in certain aspect, the present invention relates to a method for preparing a polythioamide by reacting a polyamide having its amide repeating unit at least partly in a side chain of the polymer with 2,4-bis(4-methoxyphenyl)-2,4-dithioxo-1,3,2,4-dithiadiphosphetane (C₁₄H₁₄O₂P₂S₄), 1,3,5,7-tetrakis(sulfanylidene)-2,4,6,8,9,10-hexathia-1λ5,3λ5,5λ5,7λ5-tetraphosphatricyclo[3.3.1.13,7]decane (phosphorus pentasulphide, P4S10), 2,4-Bis(p-tolylthio)-1,3,2,4-dithiadiphosphetane 2,4-disulfide (C₁₄H₁₄P₂S₆), or pentathiodiphosphorus(V) acid-P,P′-bis(pyridinium betaine)(C₁₀H₁₀N₂P₂S₅), as thionation reagent.

In a particular embodiment, the thionation reagent is 2,4-bis(4-methoxyphenyl)-2,4-dithioxo-1,3,2,4-dithiadiphosphetane (C₁₄H₁₄O₂P₂S₄), also called Lawesson's reagent (LR).

In an embodiment, the polyamide is reacted with the thionation reagent in dichloromethane, chlorobenzene, chloroform, tetrachloromethane, dimethylsulfide, dimethylsulfoxide, tetrahydrofuran, dioxane, tetrahydropyrane, trifluorotoluene or hexafluoroisopropanol as solvent.

Typically, 5 to 500,000 mols of thionation reagent, preferably 5 to 50,000 mols, is added for each mol of said polyamide.

Preferably, the polyamide is reacted with the thionation reagent at a temperature of 50-200° C., more preferably at a temperature of 50-100° C., and allowed to react until the reaction is essentially complete. For example, a reaction time of 12-120 h can be used, preferably a reaction time of 18-90 h. After the reaction, the obtained polythioamide is typically precipitated, and thus recovered as a solid product. Optionally, the precipitate can also be purified, and for example freeze-dried, to facilitate storage.

In an embodiment, at least 1%, preferably at least 5%, more preferably at least 10% and most suitably at least 20%, of the amide repeating units are thionated in the method described herein. Even levels of up to 42% thionation are possible to achieve using the method described herein, but for product solubility, it is preferred to maintain a level of ≤ 20%.

The polyamide starting material can be obtained by cationic or anionic ring opening polymerization, by free radical polymerization, transition metal catalyzed polymerization, polyaddition or polycondensation or by controlled radical polymerization. These will typically provide a polyamide with 10 to 10,000 monomer repeating units, more preferably with 20 to 1000 monomer repeating units.

The polyamide used in the thionation reaction is thus typically selected from the polyamide most closely resembling the desired product thioamide. The polyamide preferably has an average molecular weight of 2.5 kDa-1000 kDa, such as 25 kDa-500 kDa, for example 50 kDa-500 kDa. In a preferred embodiment, the average molecular weight of said polyamide is 50 kDa. In one specific embodiment, said polyamide is poly(2-ethyl-2-oxazoline), for example, said poly(2-ethyl-2-oxazoline) is selected from the products Aquazol® 5, Aquazol® 50, Aquazol® 200 and Aquazol® 500, differing from each other in their molecular weight.

Furthermore, the present invention relates to the use of said polythioamide or a polythioamide that is prepared using a method according to the present invention, in biocidal, pharmaceutical, agrochemical, diagnostic, or adhesive formulations.

Thus, for example, the biocidal properties of the polythioamides presented herein may be utilized, e.g. by using the polythioamide in a coating to transfer said biocidal properties to other materials, such as plastics, textiles, paper, ceramics or metals. Optionally, the polythioamides may be mixed with other polymers to provide a biocidal raw material for use in preparing or treating objects wherein said biocidal properties are desired.

Alternatively, the polythioamides presented herein may be used in pharmaceutical compositions as therapeutic compounds having improved therapeutic or pharmacokinetic properties, such as a prolonged circulation time.

Further, the polythioamides presented herein may be used in a drug delivery system for providing a pharmaceutical composition improved pharmacokinetic properties, such as a prolonged circulation time. For example, the polythioamides may be used as a polymer carrier of a therapeutic compound, wherein the therapeutic compound is conjugated to the polythioamide. In a more specific embodiment, said therapeutic compound is an anti-cancer drug.

In a further alternative, the polythioamides presented herein may be used in diagnostics, by their enhanced metal binding capacities compared to polyamides.

In yet another alternative, they may be used for adhesive formulations, preferably metal adhesives.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### Example

### Preparation of the Polythioamides

As a model polyamide, Aquazol50 (S0) (Kremer Pigmente) was used, and the polythioamide preparation was conducted with this commercially available model PEtOx polyamide (Mw=50 kDa). In a typical thionation reaction of said S0, dichloromethane (DCM) was used as solvent. Different molar ratios of LR and S0 were mixed in a two-neck round bottom flask at room temperature in DCM under argon gas in an oil bath. Oil bath temperature was increased to 50° C. under reflux with a bleach trap and the reaction mixture was allowed to react for 18 to 90 hours. Subsequently, the solution was cooled down to room temperature and precipitated by adding it dropwise to a 10-fold excess of toluene. The precipitate was dissolved in acetone and dialysis was carried out against acetone and water with solvent exchange for 4 to 7 days. After dialysis samples were dissolved or dispersed in water and freeze dried.

The polymers were characterized by 1H NMR, IR spectroscopy and elemental analysis. Turbidimetry measurements were made for aqueous solutions of the water-soluble thionated polymers.

TABLE 1
Reactions made for thionation of Aquazol50 (S0).

| Sample | Thionation | Molar ratio | Solvent | Time | Yield | Yield |
|---|---|---|---|---|---|---|
| name | degree | (LR:S0) | volume (ml) | (h) | (g) | % |
| S3 | 3% | 37.5 | 20 | 48 | 0.7 | 60 |
| S12 | 12% | 50 | 40 | 86 | 2.93 | 93 |
| S16 | 16% | 75 | 23 | 18 | 1 | 99 |
| S20 | 20% | 75 | 23 | 46 | 1.1 | 95 |
| S42 | 42% | 125 | 23 | 90 | 0.79 | 79 |

### Characterization—1H NMR Spectroscopy:

1H NMR spectra were measured with a Avance III 500 MHz spectrometer from Bruker Biospin (Germany) at room temperature. The spectra were calibrated to the signal of residual protonated solvent ((CD3CN): 1.94 ppm). The data was evaluated using MestReNova software. For the determination of the degree of thionation, the ratio of the integrals of signals at 1.21 and 1.02 ppm was used.

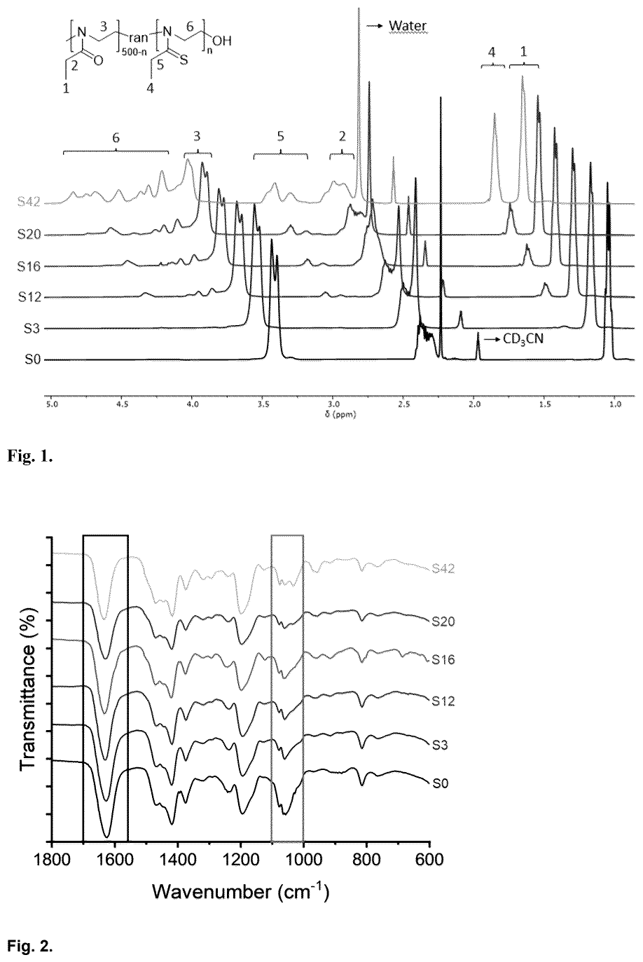

The 1H NMR spectra of S0 are characterized by three main signal groups, the side chain methyl group at δ=0.9-1.1 ppm, the side chain methylene group at δ=2.2-2.4 ppm and the backbone protons give rise to a signal around δ=3.3-3.5 ppm (FIG. 1, signals 1, 2 and 3). The thionation shifts the methyl group signals of the side chain and the new signal appear at around δ=1.21 ppm (FIG. 1, signal 4). The main backbone and side chain methylene signal intensities decreased due to shielding of the inserted sulfur atoms with more polarizable electrons. Shielding effect disperse these proton signals into higher ppm values (FIG. 1 signals 5 and 6). The thionation degrees for each samples were calculated using following equation and the characteristic signals in the 1H NMR spectra:

$$S \% = \frac{I ( S - Me )}{I ( S - Me ) + I ( O - Me )} * 100$$

where I(S-Me) defines the intensity of the methyl groups of thionated repeating units signal (FIG. 1 signal 4), and I(O-me) defines methyl groups of oxazoline repeating units signal (FIG. 1 signal 1).

### Elemental Analysis:

Elemental analysis was performed using a sulfanilamide standard. Three repetitions were made with about 2 mg samples. Sulfur to nitrogen ratio was calculated after molar quantities were determined from weight percentage in each sample.

TABLE 2
Sulfur to nitrogen ratio of thionated polymers
Elemental analysis

| Sample | S/N ratio | SD |
|---|---|---|
| S3 | 2.6% | 0.0002 |
| S12 | 10.4% | 0.001 |
| S16 | 16.8% | 0.003 |
| S20 | 21.1% | 0.001 |
| S42 | 41.9% | 0.005 |

### FTIR Spectroscopy

Infrared spectroscopy (IR) was performed with freeze dried samples using a Shimadzu IRTracer-100 instrument, equipped with a Specac ATR unit. For each spectra, 64 scans were accumulated with a spectral resolution of 4 cm⁻¹. The results are shown in FIG. 2.

### Turbidity Measurements:

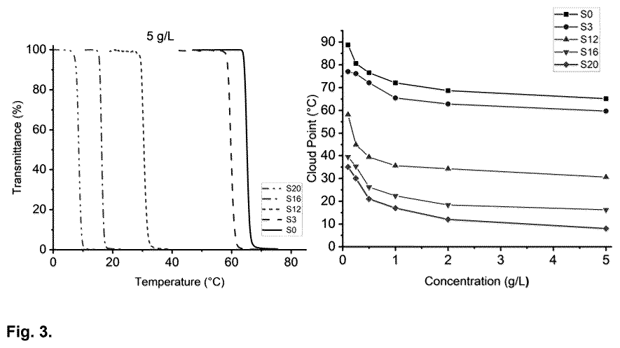

The transmittance of the samples below 20% thionation degree were measured as a function of temperature with JASCO V-750 UV-vis spectrophotometer equipped with a JASCO CTU-100 thermostat system. The transmittance was measured at 600 nm wavelength. Temperatures were measured directly from the sample while controlling the temperature with the sample holder. The heating and cooling rates were 1° C. min⁻¹. The results are shown in FIG. 3.

We observed sharp cloud points for S0, S3, S12, S16 and S20. For S0, it has been known that its lower critical solution temperature (LCST) in water can be observed in between 50° C. and 95° C., depending on its molar mass and concentration. Surprisingly, we observed that we can tune the LCST via tuning the degree of thionation. The cloud point of S20 was determined below 10° C. at the concentration of 5 g/L which indicates 20% thionation of S0 is very close to the maximum thionation degree threshold to retain any water solubility.

### INDUSTRIAL APPLICABILITY

The thioamide polymers of the present invention are more reactive than the corresponding more known amides. The polythioamides of the invention, having their polyamide groups at least partly in their side groups, also have a lower oxidation potential, as well as a particularly high affinity for metals, such as copper. Further, they could have a prolonged circulation time in drug delivery systems.

As a result of these properties, these products are highly useful e.g. in biocidal, pharmaceutical, diagnostic, or adhesive formulations.

### CITATION LIST

### Patent Literature

EP2484655A1

### Non Patent Literature

Mylêne Delêtre and Guy Levesque, Macromolecules 1990, 23, 4876-4878

1. A polythioamide comprising thioamide repeating units positioned at least partly in the side chains of the polymer, and wherein the polythioamide has an average molecular weight of 2.5 kDa-1000 kDa.

2. The polythioamide according to claim 1, wherein the polythioamide is selected from a thionated product of a poly(2-oxazoline), poly(2-oxazine), polyacrylamide, polymethacrylamide, or polyvinylcaprolactam.

3. The polythioamide according to claim 1, having a structure containing thioamide repeating units positioned entirely in the polymer side chains.

4. The polythioamide according to claim 1, wherein the polythioamide is selected from a thionated product of a polyacrylamide, polymethacrylamide, or polyvinylcaprolactam.

5. The polythioamide according to claim 1, wherein the polythioamide has an average molecular weight of 25 kDa-500 kDa.

6. The polythioamide according to claim 1, wherein the polythioamide has a degree of substitution (DS) of at least 1%.

7. A method for preparing a polythioamide having a structure comprising thioamide repeating units positioned at least partly in the side chains of the polymer, and having an average molecular weight of 2.5 kDa-1000 kDa, the method comprising:
reacting a polyamide having its amide repeating units at least partly in a side chain of the polymer with 2,4-bis(4-methoxyphenyl)-2,4-dithioxo-1,3,2,4-dithiadiphosphetane (C₁₄H₁₄O₂P₂S₄), 1,3,5,7-tetrakis(sulfanylidene)-2,4,6,8,9,10-hexathia-1λ⁵,3λ⁵,5λ⁵,7λ⁵-tetraphosphatricyclo[3.3.1.1^{3,7}]decane (phosphorus pentasulphide, P₄S₁₀), 2,4-Bis(p-tolylthio)-1,3,2,4-dithiadiphosphetane 2,4-disulfide (C₁₄H₁₄P₂S₆), or pentathiodiphosphorus(V) acid-P,P′-bis(pyridinium betaine)(C₁₀H₁₀N₂P₂S₅), as a thionation reagent.

8. The method according to claim 7, wherein the polyamide is reacted with the thionation reagent, 2,4-bis(4-methoxyphenyl)-2,4-dithioxo-1,3,2,4-dithiadiphosphetane (C₁₄H₁₄O₂P₂S₄).

9. The method according to claim 7, wherein the polyamide is reacted with the thionation reagent at a temperature of 50-200° C.

10. The method according to claim 7, wherein 5 to 500,000 mols of the thionation reagent is added for each mol of polyamide.

11. The method according to claim 7, wherein at least 1% of the amide repeating units are thionated.

12. The method according to claim 7, wherein the polyamide is obtained by cationic or anionic ring opening polymerization, by free radical polymerization, or by controlled radical polymerization.

13. (canceled)

14. The polythioamide according to claim 1, wherein the polythioamide is selected from a thionated product of a poly(2-oxazoline), poly(2-oxazine), polyacrylamides, polymethacrylamides, polyvinylpyrrolidone, or poly(n-acryloyl glycinamide).

15. The polythioamide according to claim 1, wherein the polythioamide has a degree of substitution (DS) of at least 20%.

16. The method according to claim 1, wherein the polythioamide is a homopolymer consisting of thioamide repeating units.

17. The method according to claim 1, wherein a therapeutic compound is conjugated to the polythiomide.

18. The method according to claim 7, wherein 5 to 50,000 mols of the thionation reagent is added for each mol of polyamide.

19. The method according to claim 7, wherein at least 10% of the amide repeating units are thionated.

20. The method according to claim 7, wherein the polyamide is obtained by cationic or anionic ring opening polymerization, by free radical polymerization, or by controlled radical polymerization with 25 to 10,000 monomer repeating units.

21. The method according to claim 7, the polyamide is reacted with the thionation reagent in a solvent comprising a member selected from the group consisting of dichloromethane, chlorobenzene, chloroform, tetrachloromethane, dimethylsulfide, dimethylsulfoxide, tetrahydrofuran, dioxane, tetrahydropyrane, trifluorotoluene, and hexafluoroisopropanol.
